(19) United States
(12) Patent Application Publication
(10) Pub. No.: US 2003/0009741 A1
(43) Pub. Date: Jan. 9, 2003

(54) Method and apparatus for development of a business process software application

(76) Inventors: Tsung-Wei Tu, Tainan (TW); Han-Chao Lee, Taipei (TW); Bing-Yao Liao, Taipei Hsien (TW); Yu-Feng Hsieh, Miaoli (TW)

Correspondence Address: BIRCH STEWART KOLASCH & BIRCH, PO BOX 747, FALLS CHURCH, VA, 22040-0747, US

(21) Appl. No.: 09/991,736

(22) Filed: Nov. 26, 2001

(30) Foreign Application Priority Data
Jul. 6, 2001 (TW) 90116631

(51) Int. Cl. G06F 9/44

(52) U.S. Cl. 717/104

(57) ABSTRACT

A method for development of a business process software application which comprises an action object for causing a computer system to implement an activity of a business process. The method comprises the steps of: storing a plurality of business objects, receiving a first description of a flow of the business objects, and generating the action object by combining the business objects according to the first description.

### BACKGROUND OF THE INVENTION

1. Field of the Invention

The present invention relates to a development methodology of a business process software application, particularly to an object-oriented method and apparatus for development of a business process software application.

2. Description of the Prior Art

A business process comprises many activities. For example, the business process for trading between a costumer and seller comprises activities of ordering, inventorying, accounting, delivering and messaging. In the operation of a business process software system, a series of pages appear on the screen for collecting essential data from relevant persons. Then, the collected data are processed, stored in a database of the system or determine the flow of the pages.

There are many development methodologies available to a business process application developer. However, a conventional development methodology does not provide a sufficiently object-oriented environment since the methodology designers does not bring up a standardized multi-layer structure of the business process. The conventional methodology only provides few basic business objects or functions so that the developer should do lots of work in hard-coding when he tries to link those objects for a complete application. It is disagreeable for the developer.

### SUMMARY OF THE INVENTION

Therefore, the object of the present invention is to provide a sufficiently object-oriented development methodology of a business process software application.

The present invention provides a method for development of a business process software application which comprises an action object for causing a computer system to implement an activity of a business process. The method comprises the steps of: storing a plurality of business objects, receiving a first description of a flow of the business objects, and generating the action object by combining the business objects according to the first description.

The present invention further provides a method for development of a business process software application, wherein the application comprises a plurality of action objects and page objects for causing a computer system to implement an activity of a business process. The method comprises the steps of storing a plurality of business and form objects through which the business objects obtain input data, receiving a first description of flows of the business objects and generating the action objects by combining the business objects accordingly, receiving a second description of layouts of the form objects and generating the page objects by combining the form objects accordingly, and receiving a third description of a flow of the action and page objects and combining the action objects accordingly.

The present invention further provides an apparatus for development of a business process software application which comprises an action object for causing a computer system to implement an activity of a business process. The apparatus comprises a means for storing a plurality of business objects, a means for receiving a first description of a flow of the business objects, and a means for generating the action object by combining the business objects according to the first description.

The present invention brings up a four-layer structure wherein a business process comprises activities composed of pages and actions, and each of pages and actions is constituted by forms and business logics respectively. The business logics and corresponding forms are ready for the developer. Thus, a complete application is derived only by generating descriptions of the layout of the forms and the flows of the business logics, pages, actions and the activities.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a diagram showing a structure of a business process according to one embodiment of the invention.

FIG. 2 is a block diagram showing an apparatus for development of a business process according to one embodiment of the invention.

FIG. 3A˜3C are diagrams showing a GUI of an apparatus for development of a business process according to one embodiment of the invention.

FIG. 4 is a flowchart of a method for development of a business process according to one embodiment of the invention.

### DETAILED DESCRIPTION OF THE INVENTION

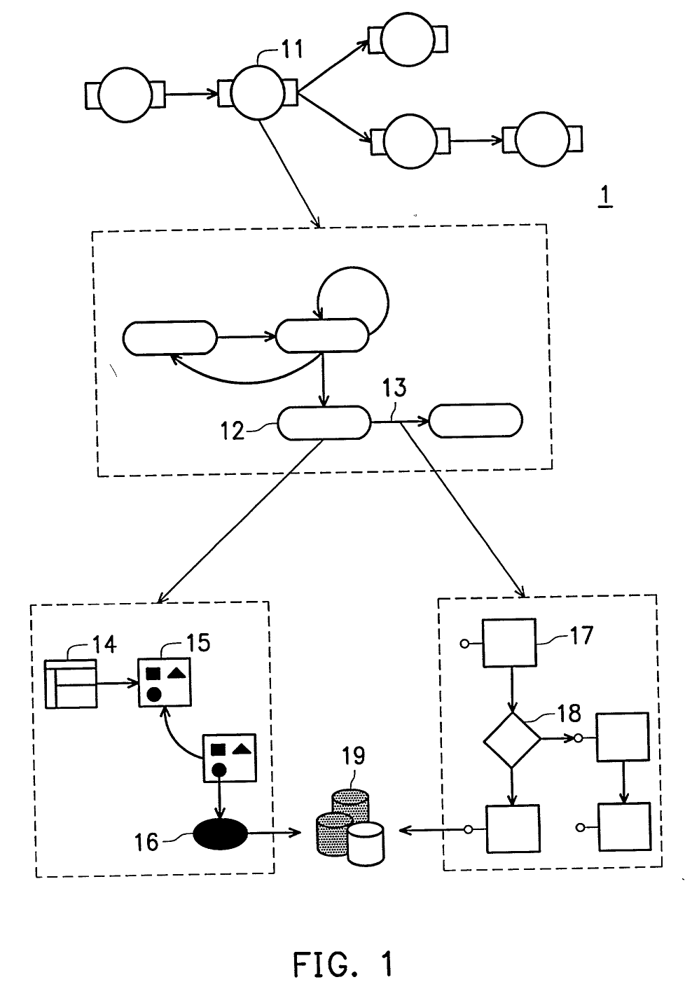

FIG. 1 is a diagram showing a structure of a business process according to one embodiment of the invention. A business process 1 comprises activities 11, each of which is composed of pages 12, such as a page for order confirmation, and corresponding actions 13, such as validation of the order. Each of the actions 13 constitutes business logics 17, such as verification of a credit card, and a routing decision 18, such as decision of the next business logic when the credit card is invalid. Each of the pages 12 constitutes forms 15, such as a form to fill in the card number, and an image 16. The forms 15 are arranged and appear in the pages 12 according to a layout 14 in order to get data from a relevant person, which are then processed by the business logics 17. The business logics 17 send the processed data to the next business object 17, the decision 18 or stores them in a database 19. Some of the data obtained through the pages 12 are also stored in the database 19 directly.

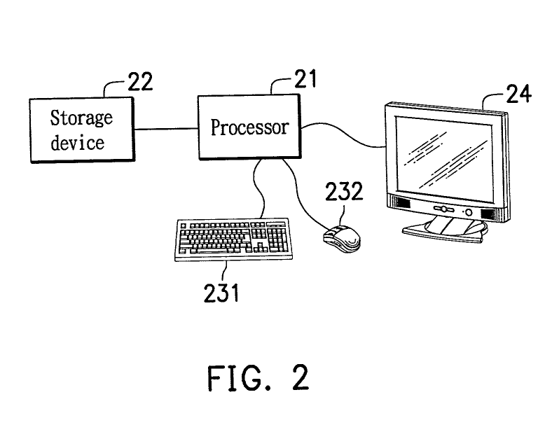

FIG. 2 is a block diagram showing an apparatus for development of a business process according to one embodiment of the invention. The apparatus comprises a processor 21, a storage device 22, an input device having a keyboard 231 and a mouse 232, and a display 24.

The storage device 22 stores business objects for implementation of the business logics and form objects for generating the forms of the corresponding business logics. The processor 21 displays a GUI (will be explained later) on the display 24. The processor 21 receives descriptions of a layout of the forms in the pages and flows of activities, pages, actions and business logics from the developer through the keyboard 231 and mouse 232. A complete application is automatically complied by the processor 21 combining those business and form objects stored in the storage device 22 according to the descriptions of the layout and flows.

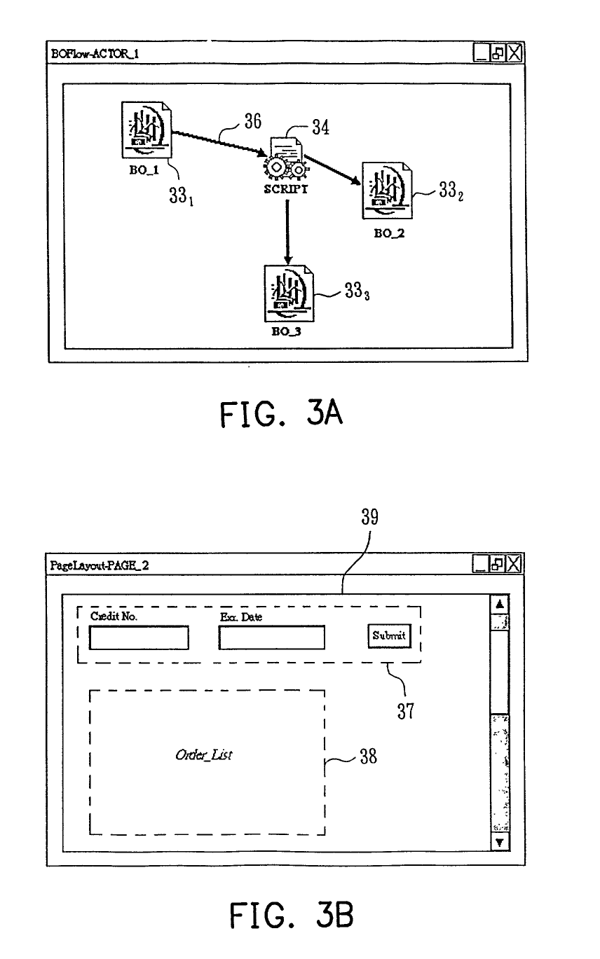

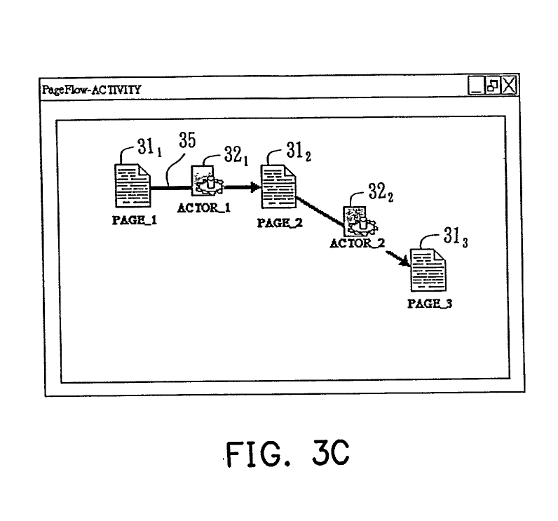

FIG. 3A is a diagram showing a GUI of the apparatus for development of a business process according to one embodiment of the invention. A GUI 3a appears on the display 42 for obtaining the description of the flow of the business logics and decision from the developer. The GUI 3a comprises icons 33₁˜33₃ for business objects BO_1, BO_2 and BO_3, icons 36 for links between the business objects BO_1, BO_2 and BO_3, and a icon 34 for a script 34 generated by the developer and implementing the routing decision. The developer puts and drags these icons 33₁˜33₃, 34 and 36 using the keyboard 231 and mouse 232 to generate a combination of the icons which represents the flow of the corresponding business logics and decision. Accordingly, the processor 21 generates a flow description ACTOR_1. Similarly, a description ACTOR_2 is also generated.

FIG. 3B is a diagram showing another GUI of the apparatus for development of a business process according to one embodiment of the invention. A GUI 3b appears on the display 42 for obtaining the description of the layout of the forms in the pages. The GUI 3b comprises icons 37 and 38 for the form objects, and a blank page 39. The developer puts and drags the icons 37 and 38 or other texts and graphics (not shown) on the page 39 using the keyboard 231 and mouse 232 to generate the layout of the forms. Accordingly, the processor 21 generates a layout description PAGE_1. Similarly, layout descriptions PAGE_2 and PAGE˜3 are also generated.

FIG. 3C is a diagram showing another GUI of the apparatus for development of a business process according to one embodiment of the invention. A GUI 3c appears on the display 42 for obtaining the description of the flow of the pages and actions. The GUI 3c comprises icons 31₁˜31₃ for page objects derived by the layout descriptions PAGE_1, PAGE_2 and PAGE_3, icons 32₁˜32₂ for actions derived by the flow descriptions ACTOR_1 and ACTOR_2, and a icon 35 for links between the page objects. The developer puts and drags these icons 31₁˜31₃, 32₁˜32₂ and 35 using the keyboard 231 and mouse 232 to generate a combination of the icons which represents the flow of the corresponding pages and actions. Accordingly, the processor 21 generates a flow description ACTIVITY.

Similarly, the processor 21 displays a GUI comprising icons for activities derived by the flow descriptions of the pages and actions, such as ACTIVITY, and icons for links between them. The developer puts and drags the icons to generate a combination which represents the flow of the activities. Then, the processor 21 generates a flow description of the activities, accordingly combines the business and form objects stored in the storage device 22 according to the layout and flow descriptions and compiles a complete software application.

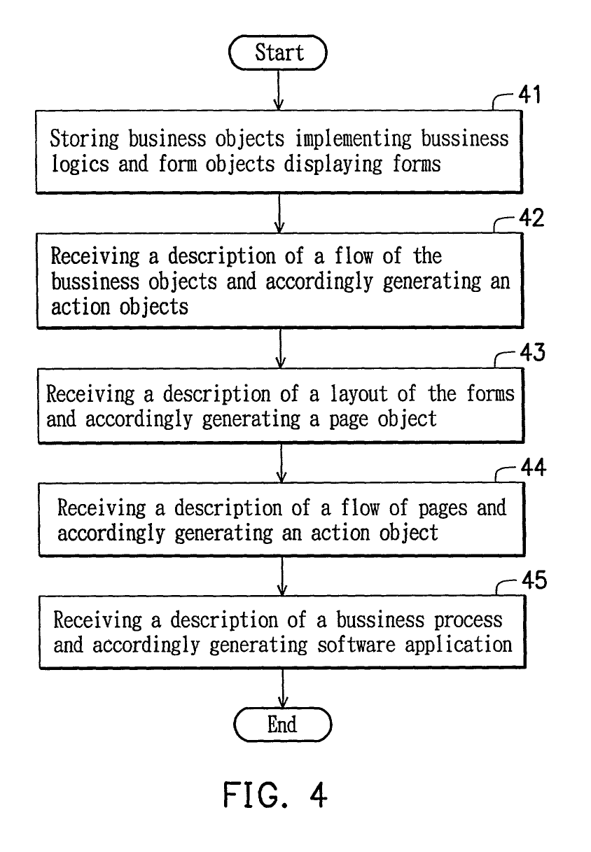

FIG. 4 is a flowchart of a method for development of a business process according to one embodiment of the invention.

In step 41, business objects for implementation of the business logics and form objects for generating the forms of the corresponding business logics are stored.

In step 42, a flow description of the business logics is generated and received and the business objects are accordingly combined to generate action objects for implementation of the actions.

In step 43, a layout description of the forms is generated and received and the form objects are accordingly combined to generate page objects for displaying the forms.

In step 44, a flow description of the pages and actions is generated and received and the action and page objects are accordingly combined to generate activity objects for implementation of the activities.

In step 45, a complete application is compiled by combining the business and form objects according to the layout and flow descriptions.

In conclusion, the present invention brings up a four-layer structure for a business process. The business and form objects are ready for the developer. A complete application is automatically compiled only by generating layout descriptions of the forms and the flow descriptions of the business logics, pages, actions and the activities. Thus eliminates the necessity of hard-coding for the development of a business process application.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for development of a business process software application which comprises an action object for causing a computer system to implement an activity of a business process, the method comprising the steps of:
storing a plurality of business objects;
receiving a first description of a flow of the business objects; and
generating the action object by combining the business objects according to the first description.

2. The method as claimed in claim 1 wherein the application further comprises a page object, the method further comprises the steps of:
storing a plurality of form objects through which the business objects obtain input data;
receiving a second description of a layout of the form objects; and
generating the page object by combining the form objects according to the second description.

3. The method as claimed in claim 2 further comprises the steps of:
receiving a third description of a flow of the action and page object; and
combining the action and page object according to the third description.

4. The method as claimed in claim 1 further comprising the steps of:
displaying a plurality of icons representing the business objects and links thereof; and
generating the first description by combining the icons.

5. A method for development of a business process software application, wherein the application comprises a plurality of action objects and page objects for causing a computer system to implement an activity of a business process, the method comprising the steps of:
storing a plurality of business and form objects through which the business objects obtain input data;
receiving a first description of flows of the business objects and generating the action objects by combining the business objects accordingly;
receiving a second description of layouts of the form objects and generating the page objects by combining the form objects accordingly; and
receiving a third description of a flow of the action and page objects and combining the action objects accordingly.

6. An apparatus for development of a business process software application which comprises an action object for causing a computer system to implement an activity of a business process, the apparatus comprising:
a means for storing a plurality of business objects;
a means for receiving a first description of a flow of the business objects; and
a means for generating the action object by combining the business objects according to the first description.

7. The apparatus as claimed in claim 6 wherein the application further comprises a page object, the storing means further stores a plurality of form objects through which the business objects obtain input data, the receiving means further receives a second description of a layout of the form objects and the generating means generates the page object by combining the form objects according to the second description.

8. The apparatus as claimed in claim 7 wherein the receiving means further receives a third description of a flow of the page and action object and the generating means further combining the page and action object according to the third description.

9. The apparatus as claimed in claim 6 further comprising a means for displaying a plurality of icons representing the business objects and links thereof and the first description is generated by combining the icons.
